(19) United States
(12) Patent Application Publication
(10) Pub. No.: US 2008/0155329 A1
(43) Pub. Date: Jun. 26, 2008

(54) Method and apparatus for intelligently deactivating tests based on low failure history

(76) Inventor: Robert S. Kolman, Allen, TX (US)

Correspondence Address: VERIGY, LTD., IP LEGAL DEPARTMENT, 10100 N. TANTAU AVENUE, CUPERTINO, CA, 95014-2540, US

(21) Appl. No.: 11/642,501

(22) Filed: Dec. 20, 2006

(51) Int. Cl. G06F 11/00

(52) U.S. Cl. 714/33; 714/E11.001

(57) ABSTRACT

Methods and apparatuses utilize test sequencing logic to bypass tests of a test program that provide statistically low test information.

### BACKGROUND OF THE INVENTION

The present invention relates generally to mass production device testing, and more particularly to a novel technique for decreasing testing time by intelligently deactivating tests based on low failure history.

During mass production of many devices, for example integrated circuit devices, the devices are tested for quality control purposes. Industrial testers of devices, for example along a manufacturing line, may run a number of different tests on each device. Depending on the complexity of both the device under test and the tests to be run on the device, the execution time for testing each device may be significant.

Industrial testers are typically very costly items. In production environments, it is often quite important to maximize the throughput of tested devices. However, when the test time for each device is high, testing may act as a bottleneck in the production process.

Accordingly, a need exists for a technique for improving the overall testing time of a run of devices under test.

### SUMMARY OF THE INVENTION

Embodiments of the invention utilize test sequencing logic to bypass tests that provide statistically low test information.

In one embodiment, a method for dynamically bypassing tests of a set of tests to be conducted on a plurality of devices under test in a given test run includes collecting test results statistics associated with bypassable tests in the set of tests, determining, based on the statistics of respective bypassable tests, whether respective bypass criteria associated with any of the bypassable tests have been met, and bypassing bypassable tests whose respective bypass criteria have been met on subsequent executions of the set of tests for subsequent devices being tested.

In one embodiment, a computer readable storage medium tangibly embodying computer executable program instructions implements a method for dynamically bypassing tests of a set of tests to be conducted on a plurality of devices under test in a given test run, including collecting test results statistics associated with bypassable tests in the set of tests, determining, based on the statistics of respective bypassable tests, whether respective bypass criteria associated with any of the bypassable tests have been met, and bypassing bypassable tests whose respective bypass criteria have been met on subsequent executions of the set of tests for subsequent devices being tested.

In one embodiment, a test sequencing apparatus for dynamically bypassing tests of a set of tests to be conducted on a plurality of devices under test in a given test run of a device tester includes a test results statistics collector which collects test results statistics associated with bypassable tests in the set of tests executed by the device tester, and test bypass logic which determines, based on the statistics of respective bypassable tests, whether respective bypass criteria associated with any of the bypassable tests have been met, and which effects bypassing of bypassable tests whose respective bypass criteria have been met on subsequent executions of the set of tests for subsequent devices being tested.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of an automated test system;

FIG. 2 is a block diagram illustrating component interaction between a GUI interface and a device under test in the test system of FIG. 1;

FIG. 3 is a block diagram of the GUI software which illustrates the functionality of the test configuration functionality;

FIG. 4 is a structural diagram illustrating an example graphical sub-structure representing a single test suite;

FIG. 5 is a structural diagram illustrating an example test program;

FIG. 6 is a flowchart illustrating an exemplary method for dynamically bypassing tests of a test program;

FIG. 7 is a flowchart illustrating an exemplary embodiment of a test bypassing method that may be followed by test sequencing logic;

FIG. 8 illustrates a flowchart illustrating an exemplary embodiment of a test bypassing method that may be followed by test sequencing logic;

FIG. 9 is a block diagram of a system which employs test bypass logic in a device tester to dynamically bypass tests.

### DETAILED DESCRIPTION

Embodiments of the invention utilize test sequencing logic to bypass tests that provide statistically low test information.

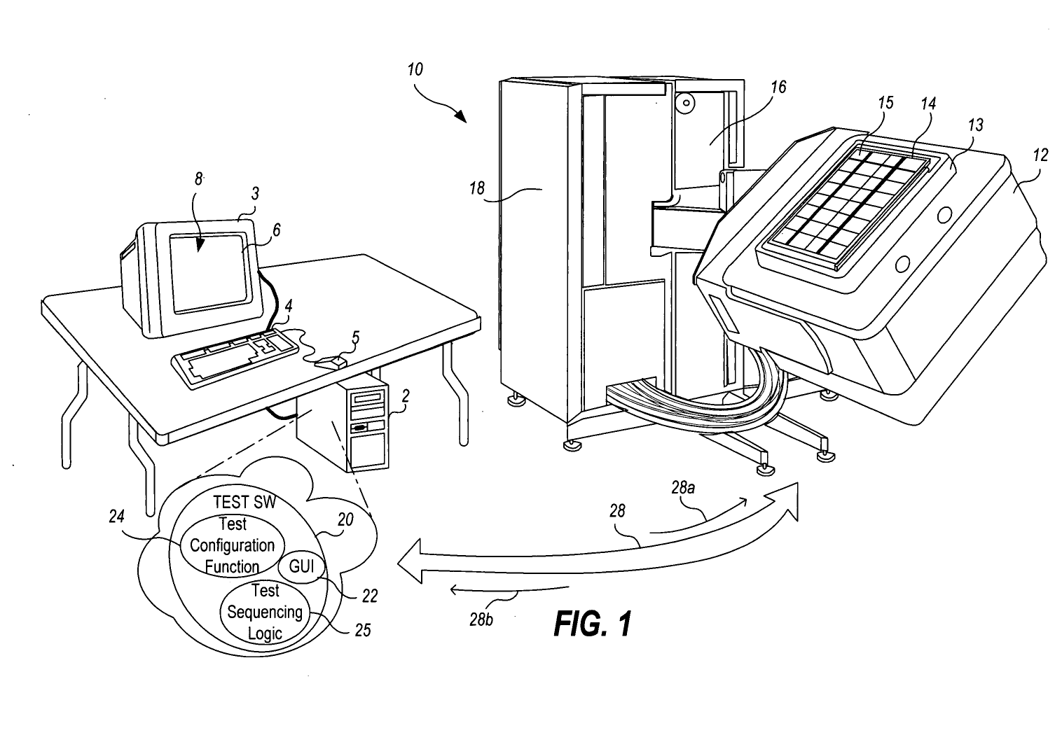

Turning now to the drawings, FIG. 1 is a view of an industrial tester 10. For purposes of illustration, the details of the tester 10 shall be discussed herein in terms of the test system 10 being an Verigy 93000 Systems-on-a-Chip (SOC) Series test system, manufactured by Verigy, Inc., of Palo Alto, Calif. However, it is to be understood that the novel features of embodiments described herein may be applied to any type of tester which tests groups of any type of device in test runs.

The test system 10 comprises a test head 12 for interfacing with and supplying hardware resources to a device under test (DUT) 15, a manipulator 16 for positioning the test head 12, a support rack 18 for supplying the test head 12 with power, cooling water, and compressed air, and a workstation 2.

The test head 12 comprises all the tester electronics, including digital and analog testing capabilities required to test the DUT, such as obtaining test measurements for parameters of interest of the DUTs. The test head 12 is connected to a DUT interface 13. The device under test (DUT) 15 may be mounted on a DUT board 14 which is connected to the tester resources by the DUT interface 13. The DUT interface 13 may be formed of high performance coax cabling and spring contact pins (pogo pins) which make electrical contact to the DUT board 14. The DUT interface 13 provides docking capabilities to handlers and wafer probers (not shown).

The test head 12 may be water cooled. It receives its supply of cooling water from the support rack 18 which in turn is connected by two flexible hoses to a cooling unit (not shown). The manipulator 16 supports and positions the test head 12. It provides six degrees of freedom for the precise and repeatable connection between the test head 12 and handlers or wafer probers. The support rack 18 is attached to the manipulator 16. The support rack 18 is the interface between the test head 12 and its primary supplies (AC power, cooling water, compressed air).

An operator may interact with the tester 10 by way of a computer or workstation (hereinafter referred to as “workstation”). The workstation 2 is the interface between the operator and the test head 12. Tester software 20 may execute on the workstation 2. Alternatively, tester software may execute in the test head 12 or another computer (not shown), where the workstation 2 may access the tester software remotely. In one embodiment, the workstation 2 is a high-performance Unix workstation running the HP-UX operating system or a high-performance PC running the Linux operating system. The workstation 2 is connected to a keyboard 4 and mouse 5 for receiving operator input. The workstation 2 is also connected to a display monitor 3 on which a graphical user interface (GUI) window 8 may be displayed on the display screen 6 of the monitor 3. Communication between the workstation 2 and the test head 12 may be via direct cabling or may be achieved via a wireless communication channel, shown generally at 28.

The tester software 20, which is stored as program instructions in computer memory and executed by a computer processor, comprises test configuration functionality 24 for configuring tests on the tester 10, and for obtaining test results. The tester software 20 also comprises GUI interface 22 which implements functionality for displaying test data. Test data may be in the form of any one or more of raw test data 28b received from the test head 12, formatted test data, summary data, and statistical data comprising statistics calculated based on the raw test data. GUI interface 22 may detect and receive user input from the keyboard 4 and mouse 5, and which generates the GUI window 8 on the display screen 6 of the monitor 3.

The tester software 20 allows download of setups and test data 28a to the test head 12. All testing is carried out by the test head 12, and test results 28b are read back by the workstation 2 and displayed on the monitor 3.

In one embodiment, the test software 20 is Verigy's SmarTest 93000 Series software. The SmarTest software includes a Test Editor which operates as test configuration functionality 24 to allow setting up a test program known in SmarTest as a “Testflow”. A “Testflow” is an interconnected set of individual tests, called Test Suites, each one testing a particular parameter. In SmarTest, Test Suites may be logically interconnected in a multitude of different ways—sequentially, dependent on the previous/another result, while something is valid, etc. Together, all these Test Suites form a complete test of a device. As used herein the term “test program” refers to any series of tests to be executed on a device under test in a particular order. A SmarTest Testflow is therefore a test program.

In one embodiment, where the tester software 20 is the Verigy SmarTest, the test configuration functionality 24 is called the Testflow Editor. The Testflow Editor provides menus and dialogues that allow an operator access to all provided functions for creating, modifying and debugging a Testflow. Testflows may be set up and executed through the Testflow Editor. Testflow icons are selected via mouse selection from within an Insert pulldown menu (not shown). Icons can be manipulated by highlighting icons in an existing testflow and using an Edit menu (not shown).

The tester software 20 includes test sequencing logic 25 which controls the sequencing of tests sent to the tester for execution.

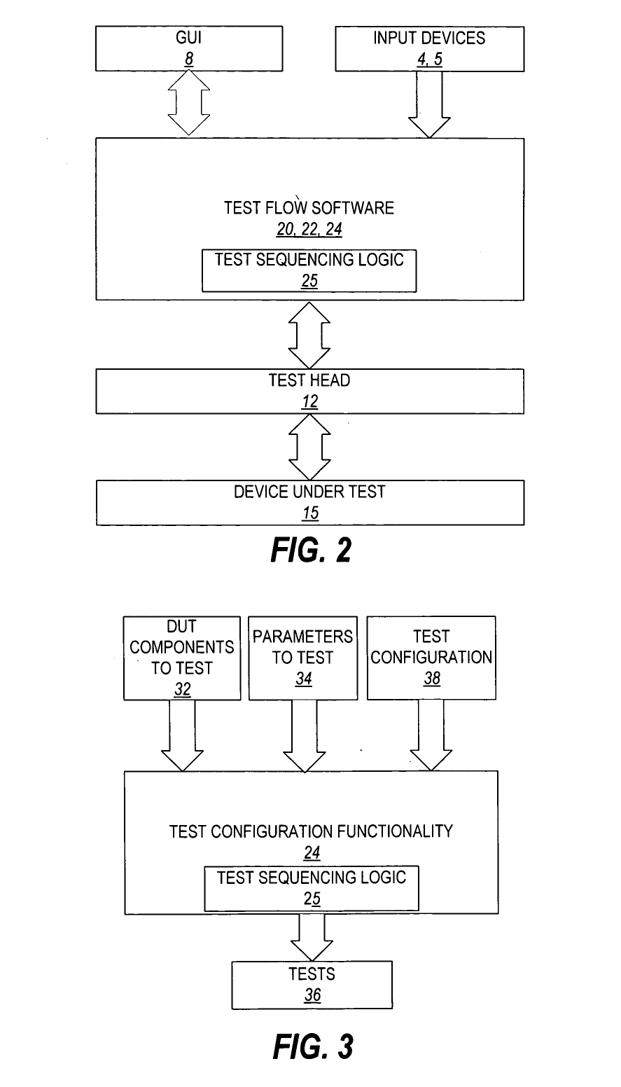

FIG. 2 is a block diagram illustrating the interaction between the GUI interface 8 and DUT 15 in the test system 10 of FIG. 1. As illustrated, the test configuration functionality 24 presents the GUI window 8 to the operator (via display screen 6 of display 3). The GUI interface 22 collects operator input (via keyboard 4 and mouse 5) to set up, download test information and test data, and initiate execution of testing of the DUT 15 by the test head 12. The test head performs tests of the DUT 15 as instructed by test sequencing logic 25 of the test software 20 and collects test results. The test results are uploaded from the test head 12 to the GUI interface 22 of the test software 20, which updates the GUI window 8 presented to the operator with the test results.

FIG. 3 diagramatically illustrates the functionality of the test configuration functionality 24. As shown, the test configuration functionality 24 collects information about components 32 of the DUT 15 to be tested and associated parameters 34 to be tested for each component 32. The test configuration functionality 24 provides a series of dialogues that allow the operator to enter information regarding each device component 32 to be tested and the parameters 34 to be tested on that component 32. The test configuration functionality 24 also includes the test sequencing logic 25 which determines and controls the sequencing (i.e., ordering) of tests to be executed by the tester. Configuration parameters 38 used by the test sequencing logic 25 may be configured by a test operator.

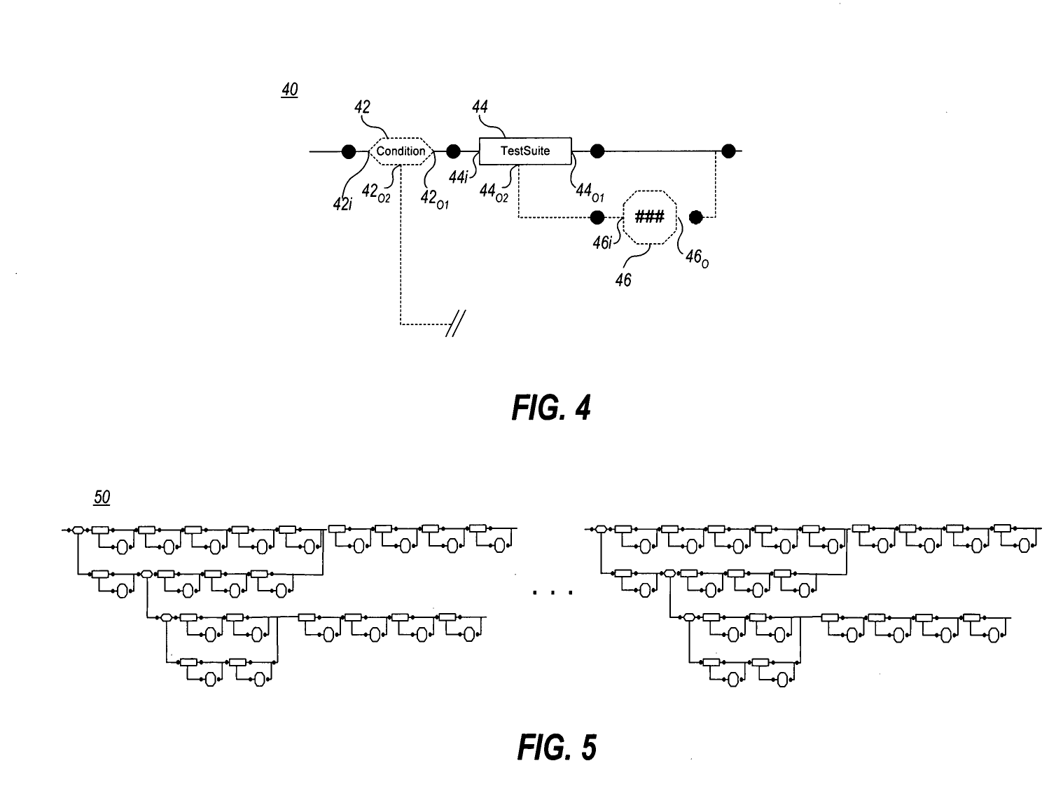

FIG. 4 illustrates an example graphical sub-structure 40 of a test program that may be generated by the test configuration functionality 24 of FIG. 3.

In the particular embodiment shown, icons 42, 44, 46 are used to represent conditions 42, test suites 44, and bins 46, discussed hereinafter.

Each test suite icon 44, represented by a rectangular shape, represents an individual, independent, executable device test (a functional test, for example). The test may test a single parameter of a single component of the DUT 15, or may test a plurality of parameters of one or more components of the DUT 15. In the illustrative embodiment, the test flow can be made to be, or not to be, dependent on the results of another test. If a given test is not dependent on the results of another test, the give test is configured as a simple “run” test suite icon. If the given test is to be made dependent on the results (e.g., pass/fail) of another test, the given test is configured as a “run and branch” test icon. The “run” and “run and branch” test icons are presented herein for purposes of illustration only. Other test icon types beyond the scope of the present invention may be defined. Furthermore, the executable that the icon represents may be any type of executable.

Each bin icon 46, represented by an octagonal or a triangular shape, represents a number of devices that fall into a similar category. For example, in the illustrative embodiment, hexagonal bins are storage bins for listing the device numbers of devices that fail a test suite associated with the bin. Of course, other bin icon types beyond the scope of the present invention may be defined, such as bins that store device identifiers of devices that pass the associated test suite and bins that store device identifiers of devices that have not yet been tested.

Each condition icon 42, represented by a hexagonal shape, represents a condition or set of conditions that determine the flow control of a branch, a while loop, a for loop, a repeat loop, or other flow control.

Each icon 42, 44, 46 includes an input 42ᵢ, 44ᵢ, 46ᵢ, and one or more outputs 42ₒ₁, 42ₒ₂, 44ₒ₁, 44ₒ₂, 46ₒ. The sequence of the test program is represented by connecting lines, or “connectors” between the outputs of the various icons and inputs of other icons. During execution of a test program, the test program executes an executable associated with an icon, and flow moves to the icon whose input is connected to its output. In the test program example shown, if more than one output exists, only one output will be selected. The selected output typically depends on the results of the executable represented by the icon. For example, referring to the condition icon 42 in FIG. 4, two outputs 42ₒ₁ and 42ₒ₂ exist. However, during execution of the test program, flow of the test program will pass to only one of the outputs 42ₒ₁ and 42ₒ₂, and the determination of which output the test program will follow depends on the results of a conditional test defined in the executable represented by the conditional control flow icon 42. Similarly, test suite icon 44 also has two outputs 44ₒ₁ and 44ₒ₂. During execution of the test program, flow passes to only one of the outputs 44ₒ₁ and 44ₒ₂, depending on the results of a conditional test defined in the executable represented by the test suite icon 44. Since one of the outputs 44ₒ₂ is connected to the input of a failure bin 46, output 44ₒ₂ is selected if the test results indicate a failure on the component or pin tested by the executable represented by the test suite icon 44. Otherwise, output 44ₒ₁ is selected.

A typical test program may include hundreds of tests. FIG. 5 is an example test flow map 50 of an example test program that may be generated by test configuration functionality 24. As illustrated, the test flow map 50 includes a number of tests (represented by rectangular boxes), conditional tests (represented by hexagonal boxes), and bins (represented by octagonal boxes). Connectors between the test suites, conditional tests, and bins indicate the test flow of the program.

A TestProgram may be defined using the test configuration functionality 24. For example, a very simple TestProgram may be as follows:

```
Begin TestProgram
    Begin Test1
      Execute Test1
    End Test1
    Begin Test2
      Execute Test2
    End Test2
    ...
    Begin Testn
      Execute Testn
    End Testn
End TestProgram
```

The above test program may be represented graphically as shown in FIG. 5.

When a test program executes, the sequencing of the tests to be executed may initially flow in the order specified in the test program setup (for excitation, as graphically represented in the test program Editor such as in FIG. 5).

Embodiments of the invention employ test sequencing logic that analyzes test performance in realtime and allows bypassing of tests which, based on their test performance history, add little or no useful diagnostic knowledge in the testing of a set of devices under test. In particular, test sequencing logic may utilize test result statistics to intelligently and dynamically determine whether, and/or how often, to continue executing a test.

As previously mentioned, test execution time is a major aspect of the cost of test that the tester realizes during the production lifecycle. Test sequencing logic may be employed to reduce the cost of test by dynamically and intelligently controlling test execution on a test by test basis. The reduction in test execution time may be realized by simply bypassing tests that no longer provide (or at least, which provide at a statistically very low rate) any useful test information.

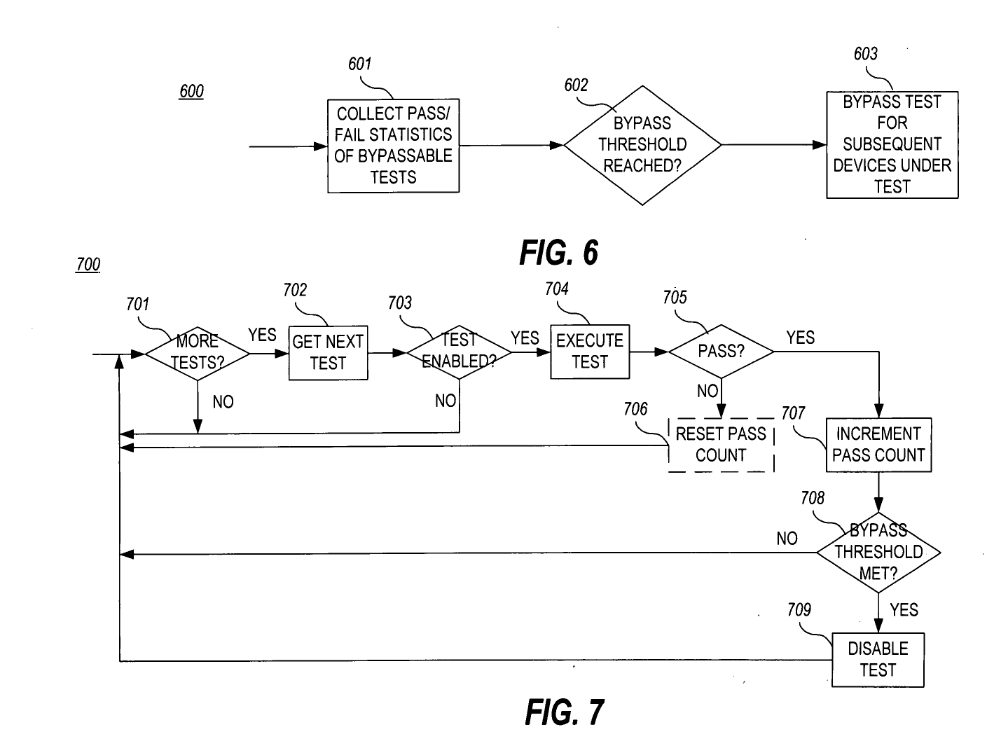

FIG. 6 is a flowchart illustrating an exemplary method for dynamically bypassing tests which statistically provide low information. In this method, test results statistics associated with bypassable tests in a set of tests (e.g., a test program) are collected (step 601). Based on the statistics of respective bypassable tests, a determination is made as to whether respective bypass criteria associated with any of the bypassable tests have been met (step 602). Any bypassable tests whose respective bypass criteria have been met are then bypassed on subsequent executions of the set of tests for subsequent devices being tested (step 603).

Bypass criteria may be set up according to various metrics. One metric that may be used for determining bypass criteria is a predefined minimum number of pass results overall. Another metric that may be used for determining bypass criteria is a predefined minimum number of consecutive pass results. Another metric that may be used for determining bypass criteria is a combination of a predefined minimum number of pass results overall followed by a predefined minimum number of consecutive pass results.

FIG. 7 is a flowchart illustrating an exemplary embodiment of a method 700 followed by test sequencing logic. In this method, the test sequencing logic begins by determining whether there are tests in a test program that are awaiting execution (step 701). If there are, then a next test in the test program is selected (step 702). The test sequencing logic determines whether the test is enabled (step 703)—that is, whether the test is not currently being bypassed. In one embodiment, the test has associated with it a bypass flag which indicates whether or not the test is to be bypassed. In one embodiment, if the bypass flag is set, then the test is considered to be “disabled”, and if the bypass flag is cleared, then the test is considered to be “enabled”. If the test is not enabled, then the test sequencing logic returns to step 701 to look for more tests awaiting execution.

If the selected test is indeed enabled, the test is caused to be executed (step 704). The result of the test is monitored (step 705). If the test passes, a pass count associated with the selected test is incremented (step 707) and compared to a bypass threshold (step 708). If the pass count has reached or exceeds the bypass threshold, then the selected test is disabled (step 709) and the test sequencing logic returns to step 701 to look for more tests awaiting execution.

If the result of the test in step 705 is a “fail”, then the test sequencing logic may return to step 701 to look for more tests awaiting execution. Alternatively, the pass count associated with the test may be reset to 0 to begin monitoring for a minimum number of “consecutive” passes. Thus, each time a pass occurs, the pass count is incremented, and each time a fail occurs, the pass count is reset to 0 to restart the consecutive pass count.

An example script, written in pseudocode, which illustrates the test sequencing logic method, is shown below and labeled “Script 1”.

Script 1

```
BEGIN TestSequence
  WHILE moreTests(TestProgram) == TRUE
  getNextTest(Test);
  IF TestEnabled(Test)==TRUE, THEN
    IF ExecuteTest(Test) == PASS, THEN
    IF AdvancePassCount(Test) >= PassThreshold (Test), THEN
      DisableTest(Test)
    END IF
    END IF
  END IF
  END WHILE
END TestSequence
wherein:
    more Tests: function which determines whether any remaining
      unexecuted tests exist
    getNextTest (Test): function returns a Test selected for
      execution
    TestEnabled(Test): function which returns a boolean value
      indicating whether or not the test named in the Test
      parameter is currently enabled (i.e., not bypassed)
    Execute Test(Test): function which effects execution of the test
      named in the Test parameter
    AdvancePassCount(Test): function which increments the
      “pass” test result counter associated with the test named in
      the Test parameter
    Pass Threshold(Test): function which returns the threshold at
      which the test named in the Test parameter may be
      disabled (i.e., bypassed)
    Disable Test(Test): function which disables, or causes to be
      bypassed, the test named in the Test parameter
```

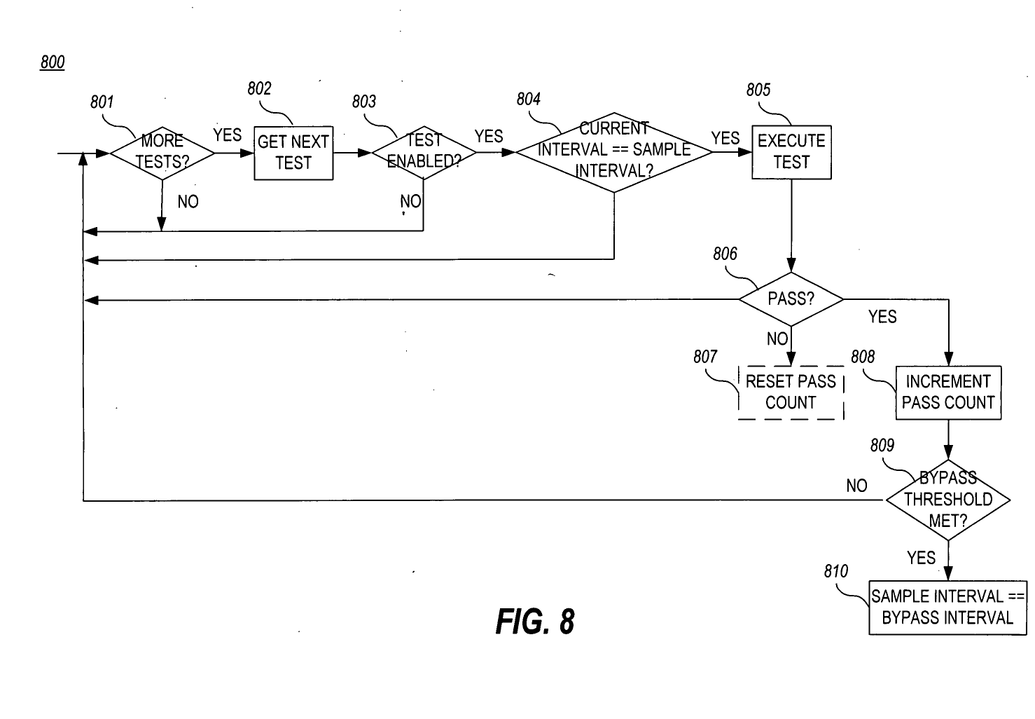

A given bypassed test may optionally be reactivated on a sampling basis at some desired frequency, so that it is still applied periodically. For example, FIG. 8 illustrates a flowchart illustrating an exemplary embodiment of a method 800 followed by test sequencing logic. In this method, the test sequencing logic begins by determining whether there are tests in a test program that are awaiting execution (step 801). If there are, then a next test in the test program is selected (step 802). The test sequencing logic determines whether the test is enabled (step 803)—that is, whether the test is not currently being bypassed. In one embodiment, the test has associated with it a bypass flag which indicates whether or not the test is to be bypassed. In one embodiment, if the bypass flag is set, then the test is considered to be “disabled”, and if the bypass flag is cleared, then the test is considered to be “enabled”. If the test is not enabled, then the test sequencing logic returns to step 701 to look for more tests awaiting execution.

If the selected test is indeed enabled, then a check is made as to whether the current testing interval is also a sample interval (step 804). In this regard, a sample interval may be set to any number greater than “1”, wherein if the sample interval is “1”, the result of the test is sampled every time it is executed, and if the sample interval is “2”, the result of the test is sampled every other time the test is executed, and if the sample interval is “3”, the result of the test is sampled every third time the test is executed, and so on. If the current interval is a sampling interval, the test is caused to be executed (step 805). The result of the test is monitored (step 806). If the test passes, a pass count associated with the selected test is incremented (step 808) and compared to a bypass threshold (step 809). If the pass count has not yet reached the bypass threshold, the test sequencing logic returns to step 801 to look for more tests awaiting execution. If, however, the pass count has reached or exceeds the bypass threshold, then the sample interval of the selected test is set to a predetermined “bypass interval” (i.e., how often the test should be executed once it has been placed into bypass mode (step 810) and the test sequencing logic returns to step 801 to look for more tests awaiting execution.

If the result of the test in step 806 is a “fail”, then the test sequencing logic may return to step 801 to look for more tests awaiting execution. Alternatively, the pass count associated with the test may be reset to 0 to begin monitoring for a minimum number of “consecutive” passes. Thus, each time a pass occurs, the pass count is incremented, and each time a fail occurs, the pass count is reset to 0 to restart the consecutive pass count.

An example script, written in pseudocode, which illustrates the test sequencing logic method, is shown below and labeled “Script 2”.

Script 2

```
BEGIN TestSequence
  WHILE moreTests(TestProgram) == TRUE
    getNextTest(Test);
    IF TestEnabled(Test)==TRUE
    THEN
      IF ExecuteTest(Test) == PASS
      THEN
        IF AdvancePassCount(Test) >= PassThreshold(Test)
        THEN BypassInterval = GetBypassInterval(Test);
        SetSampleInterval(Test, BypassInterval)
        END IF
      END IF
    END IF
  END WHILE
END TestSequence
where:
    GetBypassInterval(Test): function which returns a value
      indicating how often the test named in the Test parameter
      should be executed after it has been configured to be
      bypassed
    SetSampleInterval(Test, BypassInterval): function which sets a
      value indicating how often the test named in the Test
      parameter should be executed
```

The test sequencing logic may further include the ability to specify, on a test by test basis, the pass threshold, the normal sampling interval, and the bypass sampling interval. An example script, written in pseudocode, which illustrates test sequencing logic configuration is shown below and labeled “Script 3”.

Script 3

```
getTestParameters(Test, BypassThreshold, BypassInterval);
setTestParameters(Test, BypassThreshold, BypassInterval);
InitializeTestParameters(Test, BypassThreshold, BypassInterval)
    BEGIN InitializeTestParameters
      Test.TestEnabled := True;
      Test.SampleInterval := 1;
      Test.BypassThreshold := BypassThreshold;
      Test.BypassInterval := BypassInterval;
      Test.PassCount := 0;
ENDInitializeTestParameters
where:
      GetTestParameters(Test, BypassThreshold, BypassInterval:
        function which obtains operator input values for the
        BypassThreshold and for the BypassInterval to be
        associated with the test named in the Test parameter
SetSampleInterval(Test, BypassInterval): function which sets a
    value indicating how often the test named in the Test
    parameter should be executed
```

The test sequencing logic may include a notification function which outputs a notification indicating that “At Device ‘N’, Test<name> has begun sampling because a failure has not been detected in <pass threshold> samples. It will now be executed every <bypass sampling interval> Devices.”

The test sequencing logic may also include a bypass reset method which allows a test operator to reset the bypass logic of a given test (or Test), or to disable the bypass logic without possibility of test bypass.

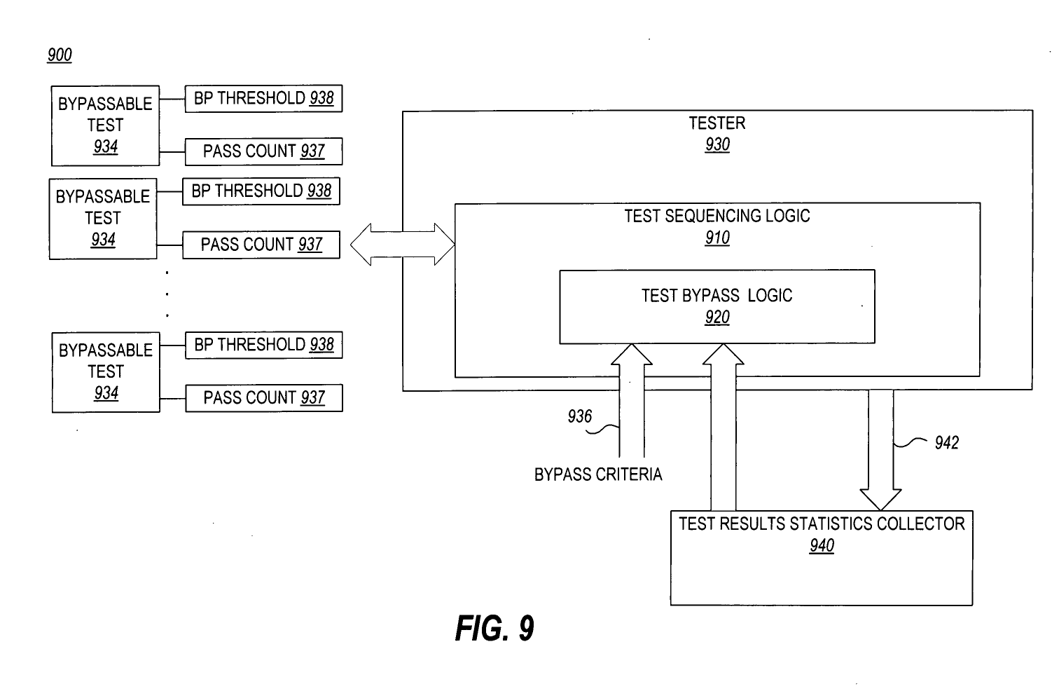

FIG. 9 is a block diagram of a system 900 which employs test bypass logic 920 in its test sequencing logic 910 of a device tester 930 to dynamically bypass tests which statistically provide low information. In this system, a test results statistics collector 940, such as statistical process control application, collects test results statistics 942 associated with bypassable tests 934 in the set of tests 932 executed by the device tester 930. The test bypass logic 920 monitors the statistics of respective bypassable tests 934 and determines whether respective bypass criteria 936 associated with any of the bypassable tests 934 have been met. The test bypass logic 920 controls the tester 930 to effect bypassing of bypassable tests whose respective bypass criteria have been met on subsequent executions of the set of tests for subsequent devices being tested.

In one embodiment, system 900 maintains a “pass count” 937 for each bypassable test in a test program which indicates the overall number of times the test generated a pass result. When a test passes, its associated pass count is incremented. A bypass threshold 938 associated with the test may also be maintained by the test sequencing logic. When a pass count reaches or exceeds the corresponding bypass threshold associated with the test, the test bypass logic 920 disables future execution of the test. In one embodiment, the test sequencing logic tests a bypass flag associated with the test prior to sequencing the test to the tester for execution. If the bypass flag is set, then the test is not queued to the tester for execution.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for dynamically bypassing tests of a set of tests to be conducted on a plurality of devices under test in a given test run, comprising:
collecting test results statistics associated with bypassable tests in the set of tests;
determining, based on the statistics of respective bypassable tests, whether respective bypass criteria associated with any of the bypassable tests have been met; and
bypassing bypassable tests whose respective bypass criteria have been met on subsequent executions of the set of tests for subsequent devices being tested.

2. The method of claim 1, wherein:
the bypass criteria associated with a respective bypassable test comprises a predefined number of pass results of the respective bypassable test during the given test run.

3. The method of claim 1, wherein:
the bypass criteria associated with a respective bypassable test comprises a predefined number of consecutive pass results of the respective bypassable test during the given test run.

4. The method of claim 1, comprising:
executing a bypassed test less frequently than for every subsequent device in the test run.

5. The method of claim 1, comprising:
executing a bypassed test;
determining, based on the test results of the executed bypassed test, whether to continue bypassing the bypassed test or to reenable the bypassed test; and
executing the bypassed test on subsequent executions of the set of tests for subsequent devices being tested if it is determined to reenable the bypassed test.

6. A computer readable storage medium tangibly embodying program instructions implementing a method for dynamically bypassing tests of a set of tests to be conducted on a plurality of devices under test in a given test run, the method comprising:
collecting test results statistics associated with bypassable tests in the set of tests;
determining, based on the statistics of respective bypassable tests, whether respective bypass criteria associated with any of the bypassable tests have been met; and
bypassing bypassable tests whose respective bypass criteria have been met on subsequent executions of the set of tests for subsequent devices being tested.

7. The computer readable storage medium of claim 6, wherein:
the bypass criteria associated with a respective bypassable test comprises a predefined number of pass results of the respective bypassable test during the given test run.

8. The computer readable storage medium of claim 6, wherein:
the bypass criteria associated with a respective bypassable test comprises a predefined number of consecutive pass results of the respective bypassable test during the given test run.

9. The computer readable storage medium of claim 6, the method comprising:
executing a bypassed test less frequently than for every subsequent device in the test run.

10. The computer readable storage medium of claim 6, the method comprising:
executing a bypassed test;
determining, based on the test results of the executed bypassed test, whether to continue bypassing the bypassed test or to reenable the bypassed test; and
executing the bypassed test on subsequent executions of the set of tests for subsequent devices being tested if it is determined to reenable the bypassed test.

11. A test sequencing apparatus for dynamically bypassing tests of a set of tests to be conducted on a plurality of devices under test in a given test run of a device tester, comprising:
a test results statistics collector which collects test results statistics associated with bypassable tests in the set of tests executed by the device tester;
test bypass logic which determines, based on the statistics of respective bypassable tests, whether respective bypass criteria associated with any of the bypassable tests have been met, and which effects bypassing of bypassable tests whose respective bypass criteria have been met on subsequent executions of the set of tests for subsequent devices being tested.
